(19) United States
(12) Patent Application Publication
(10) Pub. No.: US 2010/0012003 A1
(43) Pub. Date: Jan. 21, 2010

(54) Safes without weak parts

(76) Inventors: Yuming Huang, (US); Wanduan Huang, (US); Ailian Wang, (US); Yuzhu Huang, (US); Yuling Huang, (US); Yujian Huang, (US); Weihua Wang, (US)

Correspondence Address: YUMING HUANG, 810 MEADOWRIDGE DRIVE, AURORA, IL, 60504, US

(21) Appl. No.: 12/176,337

(22) Filed: Jul. 19, 2008

(51) Int. Cl. E05G 1/02

(52) U.S. Cl. 109/23

(57) ABSTRACT

The security class or burglary resistant capability of a safe is determined by the safe's weakest parts: combinations lock, key lock, keyboard, LCD screen, card reader, fingerprint scanner, etc (referred as weak parts below). The results of an attack to the safe include opening safe door, digging holes on safe door or body, or dysfunction of the above weak parts. The corresponding consequences are: Objects deposited inside the safe are stolen or destroyed. Even if those objects stay intact, the safe owner is no longer able to operate the safe. A new design method about safe is disclosed in this invention. The new safe has no weak parts on its surface. It's obvious that weak parts are easier to destroy than safe door and body, which is why they are called weak parts. For safes without weak parts on their surface, these weak parts (in user's hand or inside safe) are not so easy to be attacked on. The GSA class or UL Certification is improved for the new safe. Users will find the new safe is more secure and convenient to use. The design method applies to other security containers and doors.

### (2) CROSS-REFERENCE TO RELATED APPLICATIONS (Unless Included in the Application Data Sheet)

N/A

### (3) STATEMENT REGARDING FEDERALLY SPONSORED RESEARCH OR DEVELOPMENT.

N/A

(4) The names of the parties to a joint research agreement.

N/A

(5) Reference to a “Sequence Listing,” a table, or a computer program listing appendix submitted on a compact disc and an incorporation-by-reference of the material on the compact disc (see § 1.2(e)(5)). The total number of compact discs including duplicates and the files on each compact disc shall be specified.

N/A

### (6) BACKGROUND OF THE INVENTION

All the current safes have weak parts on their surface: combinations lock, key lock, keyboard, LCD screen, card reader, fingerprint scanner, etc. Users need these weak parts to open safes. It's much easier to destroy these weak parts than to destroy safe body and door. Even if the objects inside a safe stay intact after the weak parts are destroyed, the valid user (owner etc.) can no longer operate (open, close) the safe.

We invented a new design method for safe which makes all the weak parts disappear from safe surface. The new safe becomes a smooth, complete, and rigid metal brick (FIG. 2). The user facing functionality of the weak parts are moved to a handy object (a new safe key) carried by users. For example, the fingerprint scanner on current safe (FIG. 1) is split from the safe door and becomes a key (FIG. 3) used by user to open the new safe (FIG. 2).

### (7) BRIEF SUMMARY OF THE INVENTION

The security class or burglary resistant capability of a safe is determined by the safe's weakest parts: combinations lock, key lock, keyboard, LCD screen, card reader, fingerprint scanner, etc (referred as weak parts below). The results of an attack to the safe include opening safe door, digging holes on safe door or body, or dysfunction of the above weak parts. The corresponding consequences are: Objects deposited inside the safe are stolen or destroyed. Even if those objects stay intact, the safe owner is no longer able to operate the safe. A new design method about safe is disclosed in this invention. The new safe has no weak parts on its surface. It's obvious that weak parts are easier to destroy than safe door and body, which is why they are called weak parts. For safes without weak parts on their surface, these weak parts (in user's hand or inside safe) are not so easy to be attacked on. The GSA class or UL Certification is improved for the new safe. Users will find the new safe is more secure and convenient to use. The design method applies to other security containers and doors.

### (8) BRIEF DESCRIPTION OF THE SEVERAL VIEWS OF THE DRAWING

This is just a sample of how to make a current safe into a safe without weak parts.

FIG. 1. Current Safe with fingerprint scanner on its surface. Scan user's fingerprint and match to those saved in the safe. Safe door opens if a match is found.

FIG. 2. Safe without weak parts. There is no fingerprint scanner on its surface. The fingerprint scanner becomes a standalone object used as safe key. The new safe becomes a smooth, complete, and rigid metal brick.

FIG. 3. The key for the safe in FIG. 2. It is a finger print scanner with a hole to emit electromagnet wave (from an antenna inside the hole). The safe metal body and door act as antenna to receive electromagnet wave.

### (9) DETAILED DESCRIPTION OF THE INVENTION

Almost all the safes are made of metal, which is able to transfer signals. The functionality of the weak parts (combinations lock, key lock, keyboard, LCD screen, card reader, fingerprint scanner, etc.) on the surface of the existing safes is divided into two components to implement. One component (referred as PART_1 below) is moved inside the safe, the other component (referred as PART_2 below) is built into a handy object (new safe key).

The communication between PART_1 and PART_2 can be done in many different ways which are not our invention. For example, PART_2 sends out radio wave and PART_1 receives radio wave. PART_2 or user sends out sound and PART_1 receives sound. If PART_1 has some infrared sensor which is built into the gap between safe body and closed door, then PART_1 can talk to PART_2 which has a infrared sensor. X-ray may be used for the communication between PART_1 and PART_2. 1-Wire Protocol based iButton technology may be used for the communication between PART_1 and PART_2 too.

PART_2 includes all the necessary user interface objects, i.e. combinations lock, key lock, keyboard, LCD screen, card reader, fingerprint scanner, etc. These user facing parts are used to gather information from user: password input via keyboard, fingerprint scanned from fingerprint scanner, etc. PART_1 includes safe controllers and all the background parts inside the safe. PART_1 receives the information gathered by PART_2 and works with PART_2 to achieve the desired functionality. For example, fingerprint scanner (PART_2) scans user's fingerprint and converts to data. The data is transferred into safe controller (PART_1) inside safe and compared with fingerprint data base. Based on comparison result, the safe controller controls the driving mechanism to open safe door.

The connection between PART_1 and safe surface is able to withstand electrical overflow, vibration, heat, water etc. which are caused by burglar physical impacts or natural hazards.

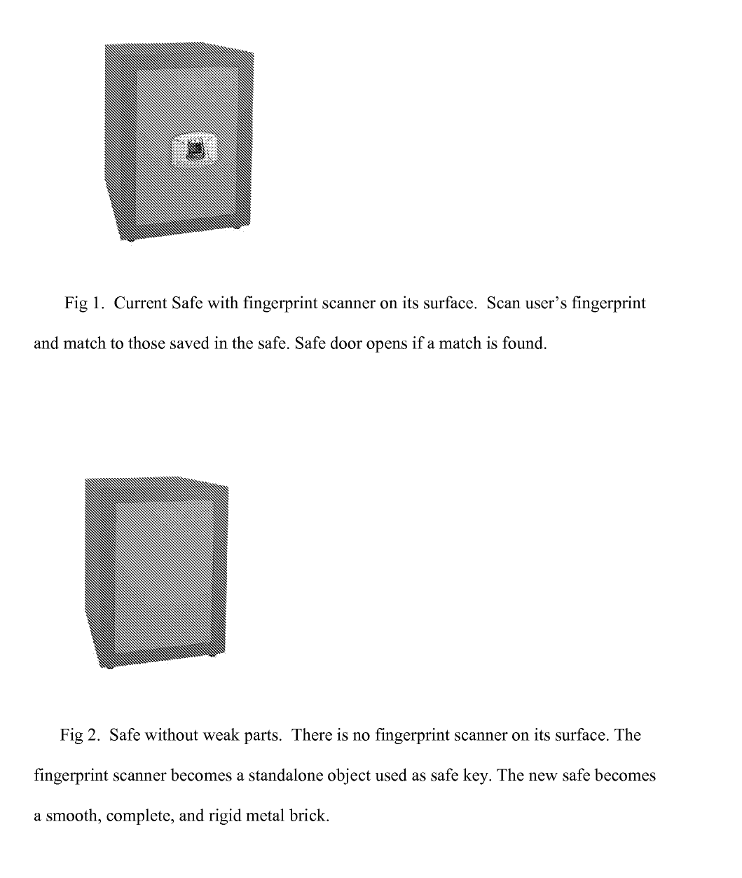

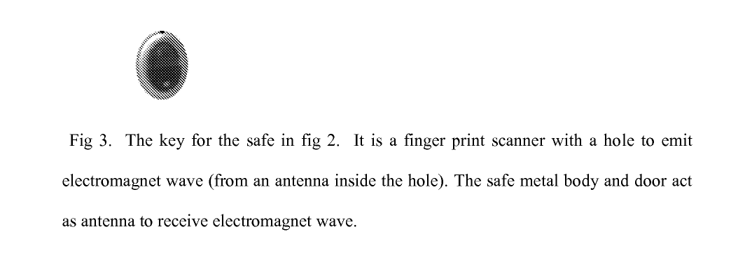

Since all the weak parts are disappeared from the safe surface, the safe becomes a smooth, complete, and rigid metal brick. Refer to FIG. 1˜3, the only difference between the old safe (FIG. 1) and the new safe (FIG. 2) is the fingerprint scanner is moved away from the surface of the old safe. It's obvious that the new safe has a better resistant capability to burglary and natural disaster.

(10) A claim or claims.

In a separate file.

(11) Abstract of the disclosure.

In a separate file.

(12) “Sequence Listing,” if on paper (see §§ 1.821 through 1.825).

N/A

1. A design method of a safe which makes all the weak parts (For example, keyboard and LCD screen on the door of an existing safe.) disappears from the safe surface or physically inaccessible. Users may use the invented safe key which bears functionality of the weak parts, to open the safe.

2. The design method of claim 1, applies to all the security containers and entrance control objects (door, gate).

3. The security containers and entrance control objects in claim 2, can be metal based (For example, safe body and door are made of metal) or multiple kinds materials based (safe body and door are made of metal or non-metal).

4. The signal transfer between a safe and a key can be done through a physical contact between the safe and the key, or without a physical contact between the safe and the key.

5. The security containers and entrance control objects in claim 2, can be with a handle or without a handle.

6. The weak parts in claim 1, includes combinations lock, key lock, keyboard, LCD screen, card reader, fingerprint scanner, etc. They are easier to destroy than safe body, door and handle, which is why they are called weak parts. They are the parts which allow users to “talk” to safe controller. At least one of them exists on the surface of all currently available safes. Right now, users can not open their safe in normal (non-destructive) way without the weak parts.

7. Security container system or entrance control system which is based on the design method in claim 2.

8. The safe in claim 4, can be a security container or an entrance control object (door, gate).
